(19) United States
(12) Patent Application Publication
(10) Pub. No.: US 2024/0265185 A1
(43) Pub. Date: Aug. 8, 2024

(54) CIRCUIT LAYOUT PROCESSING

(71) Applicant: Tencent Technology (Shenzhen) Company Limited, Shenzhen (CN)

(72) Inventors: Shengming MA, Shenzhen (CN); Jianming WANG, Shenzhen (CN); Sainan HUAI, Shenzhen (CN); Shengyu ZHANG, Shenzhen (CN); Shuoming AN, Shenzhen (CN); Xiong XU, Shenzhen (CN); Dengfeng LI, Shenzhen (CN)

(73) Assignee: Tencent Technology (Shenzhen) Company Limited, Shenzhen (CN)

(21) Appl. No.: 18/638,319

(22) Filed: Apr. 17, 2024

Related U.S. Application Data
(63) Continuation of application No. PCT/CN2023/097697, filed on Jun. 1, 2023.

(30) Foreign Application Priority Data
Jul. 25, 2022 (CN) 202210880220.2

(51) Int. Cl. G06F 30/392; G06F 119/02

(52) U.S. Cl. CPC G06F 30/392; G06F 2119/02

(57) ABSTRACT

In a circuit layout processing method, an initial circuit layout of a chip is obtained. The initial circuit layout includes initial position information of a line in the chip. A correction value of the line is obtained. The correction value is set based on an etching processing error of the chip. A boundary of the line in the initial circuit layout is corrected based on the initial position information and the correction value to obtain a corrected circuit layout.

### RELATED APPLICATIONS

The present application is a continuation of International Application No. PCT/CN2023/097697, filed on Jun. 1, 2023, which claims priority to Chinese Patent Application No. 202210880220.2, filed on Jul. 25, 2022 and entitled “CIRCUIT LAYOUT PROCESSING METHOD AND APPARATUS, DEVICE, STORAGE MEDIUM, AND PROGRAM PRODUCT.” The entire disclosures of the prior applications are hereby incorporated herein by reference.

### FIELD OF THE TECHNOLOGY

Aspects of this disclosure relate to the field of micro-nano processing technologies, including to a circuit layout processing method and apparatus, a device, a storage medium, and a program product.

### BACKGROUND OF THE DISCLOSURE

In the micro-nano processing technology, etching refers to a patterning technology that selectively etches and peels off a surface of a semiconductor substrate according to a design of circuit layout.

In related art, due to process and other reasons, a micro-nano processing device may cause etching errors during etching according to the circuit layout. Correspondingly, an etched finished product may have an expanding or narrowing size compared to the circuit layout. This phenomenon may cause characteristic parameters and performance of a finished device to deviate greatly from expectations.

### SUMMARY

Aspects of this disclosure include a circuit layout processing method and apparatus, a device, a storage medium, and a program product, which can ensure design efficiency of circuit layout while reducing impact of expanding or narrowing of a finished product size caused by an etching error. Examples of technical solutions are as follows:

According to an aspect of this disclosure, a circuit layout processing method is provided. The circuitry layout processing method is performed by a computer device, for example. In the circuit layout processing method, an initial circuit layout of a chip is obtained. The initial circuit layout includes initial position information of a line in the chip. A correction value of the line is obtained. The correction value is set based on an etching processing error of the chip. A boundary of the line in the initial circuit layout is corrected based on the initial position information and the correction value to obtain a corrected circuit layout.

According to another aspect of this disclosure, a circuit layout processing apparatus is provided. The apparatus includes processing circuitry that is configured to obtain an initial circuit layout of a chip, the initial circuit layout including initial position information of a line in the chip. The processing circuitry is configured to obtain a correction value of the line, the correction value being set based on an etching processing error of the chip. The processing circuitry is configured to correct a boundary of the line in the initial circuit layout based on the initial position information and the correction value to obtain a corrected circuit layout.

According to still another aspect, a computer device is provided. The computer device includes a processor and a memory, the memory having at least one computer instruction stored therein, and the at least one computer instruction being loaded and executed by the processor to implement the foregoing circuit layout processing method.

According to yet another aspect, a non-transitory computer-readable storage medium is provided, the non-transitory computer-readable storage medium storing instructions which when executed by a processor cause the processor to implement the foregoing circuit layout processing method.

According to yet another aspect, a computer program product or a computer program is provided, including computer instructions, and a computer-readable storage medium having the computer instructions stored thereon. A processor of a computer device reads the computer instructions from the computer-readable storage medium, and the processor executes the computer instructions, so that the computer device performs the foregoing circuit layout processing method.

The technical solutions provided in aspects of this disclosure may include at least the following beneficial effects:

For initial circuit layout of a designed chip, a line in the initial circuit layout can be corrected based on the box correction value set by the etching error, so that the circuit layout can be automatically adjusted according to an error of an etching process during a chip design stage, thereby reducing an impact of the etching error during the etching process of chip manufacturing, while ensuring design efficiency of the circuit layout of the chip.

### BRIEF DESCRIPTION OF THE DRAWINGS

FIG. 1 is a schematic diagram of an application scenario of a superconducting quantum chip according to an aspect of this disclosure.

FIG. 2 is a flowchart of a circuit layout processing method according to an aspect of this disclosure.

FIG. 3 is a schematic diagram of before and after correction of circuit layout according to the aspect of FIG. 2.

FIG. 4 is a flowchart of a circuit layout processing method according to an aspect of this disclosure.

FIG. 5 shows a line pattern according to the aspect of FIG. 4.

FIG. 6 is a schematic diagram of box generation of a line without a genus according to the aspect of FIG. 4.

FIG. 7 is a schematic diagram of a box of a line with a genus according to the aspect of FIG. 4.

FIG. 8 is a diagram of a processing effect of a dual-concentric square-shaped line pattern according to the aspect of FIG. 4.

FIG. 9 is a diagram of a processing effect of a pattern without a genus according to the aspect of FIG. 4.

FIG. 10 is a diagram of a processing effect of a pattern with a genus according to the aspect of FIG. 4.

FIG. 11 is a flowchart of a solution according to the aspect of FIG. 4.

FIG. 12 is a diagram of an engineering implementation effect of widening a CPW resonance cavity on circuit layout.

FIG. 13 is a diagram of an engineering implementation effect of widening a pad on circuit layout.

FIG. 14 is a diagram of an engineering implementation effect of widening silkscreen on circuit layout.

FIG. 15 is a block diagram of a structure of a circuit layout processing apparatus according to an aspect of this disclosure.

FIG. 16 is a schematic diagram of a structure of a computer device according to an aspect of this disclosure.

### DETAILED DESCRIPTION

To make the objectives, technical solutions, and advantages of this disclosure clearer, the following further describes implementations of this disclosure in detail with reference to the accompanying drawings.

Before aspects of this disclosure are introduced and described, some examples of terms related to aspects of this disclosure are first described.
(1) Photolithography, for example, may also be referred to as optical lithography or ultraviolet photolithography and is a precision processing process for patterning parts and an important step in semiconductor manufacturing. A photolithography technology uses exposure and development to carve a geometric pattern structure on a photoresist layer, transfers a geometric pattern from a photomask to a photosensitive chemical photoresist on a substrate, and then an exposed pattern is transferred to the substrate (wafer) by performing a series of chemical treatments (etching process).
(2) Wafer is an abbreviation of a semiconductor crystal circular wafer, and is used for example to make a semiconductor circuit. The most common wafer is a silicon wafer. An original material of the silicon wafer is silicon (mostly monocrystalline silicon), because a shape of the monocrystalline silicon is a thin slice of a cylindrical semiconductor crystal, the monocrystalline silicon is called a wafer. The wafer serves as a carrier substrate in a process of manufacturing an integrated circuit and is also used in the manufacture of solar cells.
(3) Diffraction may refer to a physical phenomenon in which a wave deviates from original straight-line propagation when encountering an obstacle. In classical physics, a wave bends and propagates to varying degrees after passing through an obstacle such as a slit, a hole, or a disk. This is diffraction. The diffraction is an inherent property of the wave.
(4) Layout may also be referred to as circuit layout, and is an example of a design drawing that describes how components in a circuit are laid out, placed, and connected, and may be a planar geometric shape description of physical situations of a real circuit. A design of the layout needs to comply with constraints such as a manufacturing process, timing, an area, and power consumption. A layout design file includes a shape, an area, and position information of each hardware unit on a chip.
(5) Photomask, also referred to as photo mask (mold) and photomask, is for example a quartz glass sheet with a chromium metal film that is covered with images of integrated circuits. The photomask copies a pattern formed on a semiconductor onto a wafer during a photolithography process of manufacturing the integrated circuits. A principle is very similar to developing a camera film, using the negative to copy an image onto a photo.
(6) Superconducting quantum chip is, for example, a central processing unit of a superconducting quantum computer. A quantum computer is a machine that uses principles of quantum mechanics to perform calculations. Based on a superposition principle and quantum entanglement of the quantum mechanics, the quantum computer has a strong parallel processing capability and can resolve some problems that are difficult for classical computers to calculate. A zero-resistance characteristic of a superconducting quantum bit and a manufacturing process close to that of an integrated circuit make a superconducting quantum computing system constructed by using the superconducting quantum bit be one of the most promising systems for achieving practical quantum computing.

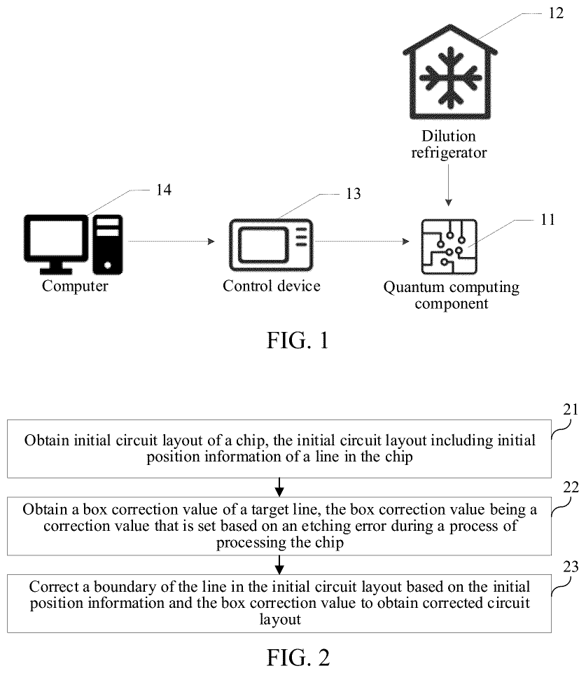

FIG. 1 is a schematic diagram of an application scenario of a superconducting quantum chip according to an aspect of this disclosure. As shown in FIG. 1, the application scenario may be a superconducting quantum computing platform. The application scenario includes: a quantum computing component 11, a dilution refrigerator 12, a control device 13, and a computer 14.

The quantum computing component 11 is a circuit that operates on a physical quantum bit. The quantum computing component 11 can be achieved as a quantum chip, such as a superconducting quantum chip near absolute zero. The dilution refrigerator 12 is configured to provide an absolute zero environment for the superconducting quantum chip.

The control device 13 is configured to control the quantum computing component 11. The computer 14 is configured to control the control device 13. For example, a written quantum program is compiled into instructions by software in the computer 14 and sends the instructions to the control device 13 (such as an electronic/microwave control system). The control device 13 converts the above instructions into electronic/microwave control signals and inputs the signals to the dilution refrigerator 12 to control superconducting quantum bit at a temperature less than 10 mK. A reading process is the opposite. A read waveform is sent to the quantum computing component 11.
(7) Coplanar waveguide (CPW) is, for example, a microwave planar transmission line with superior performance and easy processing and used for transmitting a microwave signal. A large amount of coplanar waveguide technology is used in a superconducting quantum chip.
(8) Etching/Wet etching includes, for example, photolithography etching and is an important part of a semiconductor process. The etching is a process of selectively removing an unwanted material from a surface of a silicon wafer by using a chemical or physical method. A basic objective of the etching is to correctly copy a mask pattern on a glued silicon wafer. The wet etching is an etching method that immerses an etching material in a corrosive liquid for corrosion and has advantages of good selectivity and repeatability, high production efficiency, simple device, and low costs.
(9) Micro-nano processing: A micro-nano manufacturing technology may refer to components with scales in sub-millimeter, micron, and nanometer as well as a design, processing, assembly, integration, and an application technology of parts or systems formed by these components.
(10) Component is a general term for a component and a device and is, for example, an electronic part and a constituent element in a circuit, such as resistors, capacitors, and inductors.
(11) Silkscreen, or screen printing, is for example a printed line/printed word (usually white) used to mark information such as symbols, logos, component types, and parameters on a printed circuit board (PCB). The silkscreen is not involved in functions of the PCB itself. However, information provided by the silkscreen helps manufacturers and engineers identify the PCB and different components on the PCB.
(12) Genus is, for example, a hole on a closed surface. For an orientable surface, a genus quantity (that is, a quantity of holes on the closed surface) is an integer, indicating the maximum quantity of curves that are cut along a closed simple curve without cutting off the surface. For example, a genus of a sphere is 0, and a genus of a ring is 1.
(13) Boolean operation includes a logical operation (deduction) in a computer language, including operations of union, intersection, and difference. There are operators such as AND, OR, and NOT. A result is called a Boolean value, 1 means “true”, and 0 means “false”.
(14) Pad: The pad, for example, exists on a circuit board and is a location used for connecting electronic components to lines. Solder is usually used on the pad to weld and fix pins of components to the circuit board. In classic circuits, the pads are usually polygonal pieces of copper. However, in superconducting quantum chips, a shape and a structure of the pad are different.

In a process of performing photolithography in a classic semiconductor manufacturing industry, in a case that a line width on a wafer is smaller than an exposure wavelength, image errors caused by diffraction occur, resulting in occurrence of errors. Optical proximity correction is a photolithography enhancement technology used in semiconductor production to ensure integrity of pattern edges in circuit layout. The optical proximity correction can correct and compensate for image errors by moving the pattern edges on photomask layout or changing photomask layout.

Similarly, in a manufacturing process of superconducting quantum chips, a CPW-based superconducting circuit needs to be etched. Due to process and other reasons, a (positive and negative) etching error occurs, causing device feature parameters and performance to deviate from expectations. To address this problem, in an aspect of this disclosure, error is taken into consideration in a design process of the circuit layout, and the error is compensated and offset in advance, so that the error is corrected during manufacturing. This step can be achieved by a designer manually adjusting a boundary of the line.

However, in a case that a chip scale is large, the process of manually adjusting the boundary of the line is cumbersome, which can seriously affect a chip design and manufacturing efficiency. Aspects of this disclosure provide a circuit layout processing method, which can better ensure design efficiency of circuit layout of the chip while reducing impact of expanding or narrowing of a finished product size caused by an etching error.

FIG. 2 is a flowchart of a circuit layout processing method according to an aspect of this disclosure. An execution entity of each step of the method may be a computer device. The method may include the following steps:

Step 21: Obtain initial circuit layout of a chip, the initial circuit layout including initial position information of a line in the chip.

The initial circuit layout may be a circuit layout designed and completed by a chip designer according to performance requirements of the chip.

The initial position information of the line in the initial circuit layout may include coordinate information of a boundary of the line in the initial circuit layout.

Step 22: Obtain a box correction value of the line, the box correction value being a correction value that is set based on an etching error during a process of processing the chip.

The box correction value (offset) may be an offset value used to expand the boundary of the line outward or contract inward. In other words, the box correction value is used for correcting the boundary of the line.

Because the line in the chip has a width, in the initial circuit layout, the line may be indicated by a position (a coordinate) of the boundary. The boundary of the line refers to a boundary between a region covered by the line and a region outside the line.

For example, when the boundary of the line needs to be expanded outward, an offset may be a positive value, and when the boundary of the line needs to be contracted inward, an offset may be a negative value.

The box correction value may be determined by using experimental data on etching errors under a current etching process condition. Because a manufacturing environment, an instrument difference, a process parameter, and the like affect a magnitude of the etching error, based on considerations of versatility, a compensation parameter (that is, the box correction value) in an aspect of this disclosure is selected to correspond to an experimental value given in a current processing condition.

The box correction value may be set by receiving a setting operation that is performed by a user in the setting interface.

In other words, the box correction value may be set by the user using the setting interface provided by design software. For example, the solutions of this disclosure may be executed by a computer device using the design software. The design software may provide a setting interface. The user may set the box correction value in the design software according to the box correction value through the setting interface.

For example, the setting interface may include an input box for the box correction value. The user enters the box correction value into the input box based on the etching error. After clicking “OK”, the design software can complete the setting of the box correction value.

For another example, the setting interface may include a setting option/input box for the etching error. The user may select the etching error through the setting option, or input the etching error through the input box. After clicking “OK”, the design software can determine a corresponding box correction value based on the etching error, and then complete the setting of the box correction value. The design software may be pre-set with a correspondence or a calculation formula between the etching error and the box correction value. After the design software obtains the etching error set by the user through the setting option/input box, a corresponding box correction value can be determined in combination with the correspondence or calculation formula. The correspondence or calculation formula may be set into the design software by a developer of the design software during a development process.

Step 23: Correct a boundary of the line in the initial circuit layout based on the initial position information and the box correction value to obtain corrected circuit layout.

In aspects of this disclosure, the computer device may correct a boundary of the line in the initial circuit layout based on the initial position information of the line in the chip and the box correction value to obtain a corrected circuit layout.

The corrected circuit layout is configured to prepare the line in the chip by using an etching process.

In an aspect of this disclosure, after the computer device obtains the initial position information of the line in the chip and the box correction value, the boundary of the line in the initial circuit layout may be expanded or shrunk outward or inward (depending on positive and negative attributes of the box correction value) to obtain the corrected circuit layout.

In other words, the computer device may expand a boundary of a line indicated by the initial position information to the outside of the region covered by the line, or shrink the boundary to the inside of the region covered by the line, to correct the boundary of the line in the initial circuit layout based on the initial position information based on the line in the chip and the box correction value. A distance of expansion or shrinkage is related to a numerical value of the box correction value.

For example, assuming that the box correction value is +3, the computer device may extend the boundary of the line indicated by the initial position information by 3 coordinate units (such as 3 pixel coordinates) outside the region covered by the line. Assuming that the box correction value is −3, the computer device may shrink the boundary of the line indicated by the initial position information by 3 coordinate units into the region covered by the line.

For another example, assuming that the box correction value is +3, the computer device may shrink the boundary of the line indicated by the initial position information by 3 coordinate units into the region covered by the line. Assuming that the box correction value is −3, the computer device may extend the boundary of the line indicated by the initial position information by 3 coordinate units outside the region covered by the line.

Aspects of this disclosure provide a solution for compensating line size errors caused by etching during the manufacturing process of a chip (such as a superconducting quantum chip). In this solution, an impact of the etching error on device parameters and performance is reduced. In addition, chip design efficiency is improved.

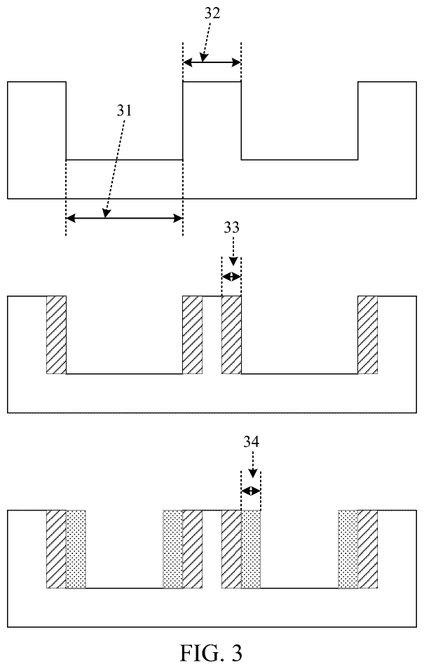

For example, FIG. 3 is a schematic diagram of before and after correction of circuit layout according to an aspect of this disclosure. Regarding a CPW line width expanding problem caused by wet etching shown in FIG. 3, negative compensation can be used in the solution of this disclosure. As shown in FIG. 3, in a CPW cross-section of a process finished product, an expected etching width is 31 and a line width is 32. If the etching is performed according to the initial circuit layout, an etching width becomes narrower due to existence of the etching error. In FIG. 3, a width of each side of the line expands outwards by 33. The initial circuit layout is corrected by using the solution of this disclosure, and the correction width on each side is a width of 34 (that is, it is expanded outward on both sides of the line). Then, based on the corrected circuit layout, the inward narrowing of the lines caused by the etching error can be compensated by etching CPW lines through the etching process.

In conclusion, by using the solutions of this disclosure, for initial circuit layout of a designed chip, a line of initial circuit layout can be corrected based on the box correction value set by the etching error, so that the circuit layout can be automatically adjusted according to an error of an etching process during a chip design stage, thereby reducing an impact of an etching process error during the etching process of chip manufacturing, while ensuring design efficiency of the circuit layout of the chip.

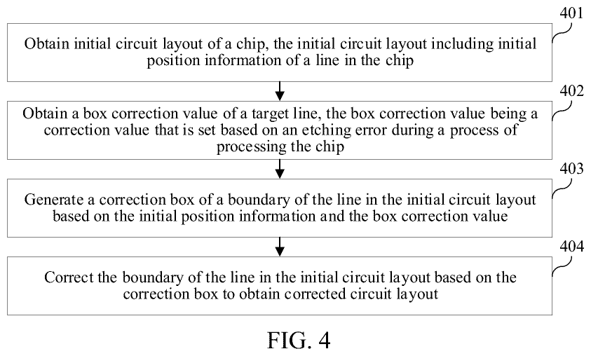

FIG. 4 is a flowchart of a circuit layout processing method according to an aspect of this disclosure. An execution entity of each step of the method may be a computer device. The computer device may be a conventional computer, such as a desktop computer, a laptop computer, a tablet computer, a personal workstation, or a server. As shown in FIG. 4, the method may include the following steps:

Step 401: Obtain an initial circuit layout of a chip, the initial circuit layout including initial position information of a line in the chip.

In an implementation, the chip is a superconducting quantum chip.

The chip may alternatively be other types of chips, such as an optical quantum chip and an ion quantum well chips.

The chip may alternatively be a conventional semiconductor chip.

In an implementation, the line may include at least one of a coplanar waveguide line, a component, and silkscreen.

Step 402: Obtain a box correction value of the line, the box correction value being a correction value that is set based on an etching error during a process of processing the chip.

In an aspect of this disclosure, the box correction value may be input by a designer.

For example, the computer device may display a parameter setting interface. The parameter setting interface may include a box correction value input box. The designer may enter the box correction value in the box correction value input box.

For another example, the parameter setting interface may include a box correction value setting column. The box correction value setting column includes options corresponding to one or more preset box correction values. The designer may select an option corresponding to a needed box correction value in the box correction value setting column.

In another implementation of this disclosure, the box correction value may alternatively be automatically obtained by the computer device. For example, the initial circuit layout corresponds to relevant parameters of a used etching process, for example, the number of the used etching process. When obtaining the initial circuit layout, the computer device may read relevant parameters of the etching process used in the initial circuit layout, and automatically match a corresponding box correction value based on the read relevant parameters.

For example, the computer device may store etching process numbers and box correction values corresponding to the etching process numbers. After reading the etching process numbers corresponding to the initial circuit layout, the computer device may query corresponding box correction values based on read etching process numbers.

After obtaining the initial circuit layout and the box correction value, the computer device may correct a boundary of the line in the initial circuit layout based on the initial position information of the line in the chip and the box correction value to obtain a corrected circuit layout. The corrected circuit layout is configured to prepare the line chip by using an etching process. For an example of the process, reference may be made to subsequent steps 403 and 404.

Step 403: Generate a correction box of the boundary of the line in the initial circuit layout based on the initial position information and the box correction value.

The computer device may generate a correction box of the boundary of the line in the initial circuit layout based on the initial position information of the line in the initial circuit layout and the box correction value.

In an implementation, the generating a correction box of the boundary of the line in the initial circuit layout based on the initial position information of the line in the initial circuit layout and the box correction value may include:

S403a: Obtain genus detection information of the line, the genus detection information being used for indicating whether a genus exists in the line.

Whether a genus exists in the line may also be referred to as whether a genus exists in a region covered by the line.

The region covered by the line may refer to the line itself and a region occupied by a chalk pattern surrounded by the line in the circuit layout. Alternatively, the region covered by the line may be a smallest circumscribed rectangle including the line or a region where a smallest circumscribed circle is located.

In actual operation, there are various closed patterns on the circuit layout. The circuit layout is usually in a GDSII format (a database file format used for data conversion of integrated the circuit layout). GDSII is a binary file that contains geometrical shape of planes in the circuit layout, text or labels, and other relevant information, and may be formed by a hierarchical structure. GDSII data may be used for reconstructing all or part of layout information.

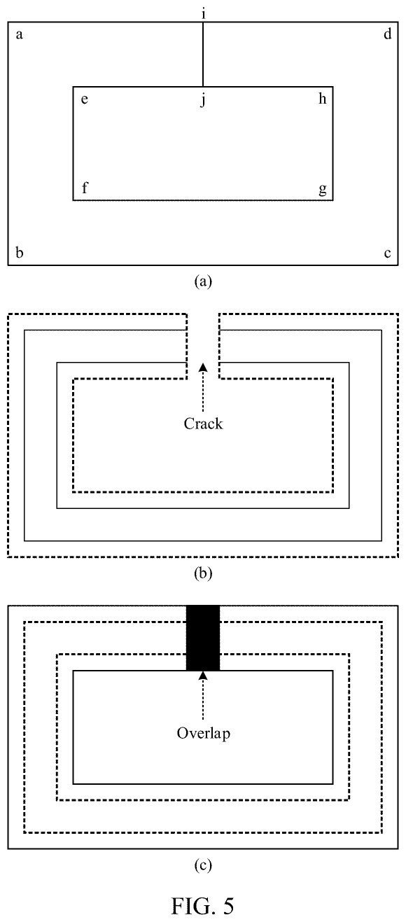

FIG. 5 shows a line pattern according to an aspect of this disclosure. Because a storage structure of the GDSII file format needs a pattern boundary to be “drawn in one stroke”, direct drawing of a pattern having a genus does not satisfy layout file requirements, such as a pattern with a “dual-concentric square” shape. To resolve this problem, an additional connecting edge is needed between the inner and outer boundaries of the pattern. When drawing, the pattern may be drawn continuously by passing through this edge, as shown in section (a) in FIG. 5. Because the computer device cannot directly distinguish this additional edge from the boundary of an original pattern, if similar polygon boundaries in a GDSII file are directly shrunk, this edge is also be shrunk, causing a crack in the pattern and the pattern no longer being “closed”, as shown in section (b) in FIG. 5. On the contrary, when widening, a phenomenon of overlapping patterns occurs, as shown in section (c) in FIG. 5. This change in a pattern structure apparently destroys an original device structure, resulting in errors in a manufacturing process.

In this regard, in an aspect of this disclosure, the computer device may first detect whether the line includes a genus. For the lines including a genus and the line not including a genus, this aspect of this disclosure uses different methods for correction.

In an implementation, when obtaining the genus detection information of the line, the computer device may perform the following steps:
(1) Obtain first genus detection information in response to position information of repeated points existing in initial position information of the line, the first genus detection information being used for indicating that a genus exists in a region covered by the line.
(2) obtain second genus detection information in response to no position information of repeated points existing in initial position information of the line, the second genus detection information being used for indicating that no genus exists in the region covered by the line.

In an aspect of this disclosure, because the storage structure of the GDSII file format needs the pattern boundary to be “drawn in one stroke”, the position information of the line in the circuit layout may be stored in a format of a point set of the boundary. The point set includes coordinates of key points on the boundary of the line.

For example, the position information of a rectangular line may include 4 pairs of coordinate points, corresponding to coordinate points of four corner points of a rectangle.

However, position information of a dual-concentric square-shaped line including a single genus may include 10 pairs of coordinate points, corresponding to coordinates of four corner points of a dual-concentric square-shaped outer box (such as point a, point b, point c, and point d in section (a) in FIG. 5), coordinates of the four corners of a dual-concentric square-shaped inner box (such as point e, point f, point g, and point h in section (a) in FIG. 5), and coordinates of two endpoints of a line connecting the inner and outer boxes (such as point i and point j in section (a) in FIG. 5).

For the line without a genus (such as a rectangular line), during the drawing process, a drawn line passes through the four corner points of the rectangle successively, and each corner point is passed only once. However, for the line with a genus (such as the line shown in section (a) in FIG. 5), during the drawing process, a drawn line passes through the two endpoints on a connection line between the inner and outer boxes twice. In other words, in the GDSII file, the two endpoints on the connection line between the inner and outer boxes appear twice in the point set of the dual-concentric square-shaped line. For more complex lines with a genus, there may be points that appear three or more times in the corresponding point set.

Based on the above principle, when determining whether a line has a genus, the computer device may determine whether there are points that appear twice or more in the position information (the point set) of the line. If yes, it is determined that the line has a genus (that is, the second genus detection information is obtained); otherwise, it is determined that no genus exists in the line (that is, the first genus detection information is obtained).

S403b: Generate the correction box based on the initial position information of the line in the initial circuit layout and the box correction value according to the genus detection information.

In an aspect of this disclosure, for the two situations of presence/absence of genus, the computer device may use different processing methods to generate the correction box.

In an implementation, the generating the correction box based on the initial position information of the line in the initial circuit layout and the box correction value according to the genus detection information may include:
adding, in response to the genus detection information indicating that no genus exists in the line, the box correction value based on the initial position information of the boundary of the line to obtain the correction box.

In an aspect of this disclosure, when it is detected that no genus exists in the line, the computer device may directly start from the boundary of the line and extend a distance outward or inward (that is, the box correction value) to obtain the correction box.

For example, when it is detected that no genus exists in the line, for a point on the boundary, a normal direction (perpendicular to a tangent direction) of the point on the boundary is determined, and then the point moving toward the outside or inside of the line to the box correction value along the normal direction is calculated based on a coordinate of the point in the initial position information, to obtain a coordinate of a corresponding point in the correction box. The above processing is performed for each point on the boundary of the line. To be specific, coordinates of each point in the correction box may be obtained.

The computer device may start from a point on the boundary of the line and calculate the point along the tangent direction of the point on the boundary.

The correction box may be a box of which a width is the box correction value. In other words, a line width of the box is the box correction value.

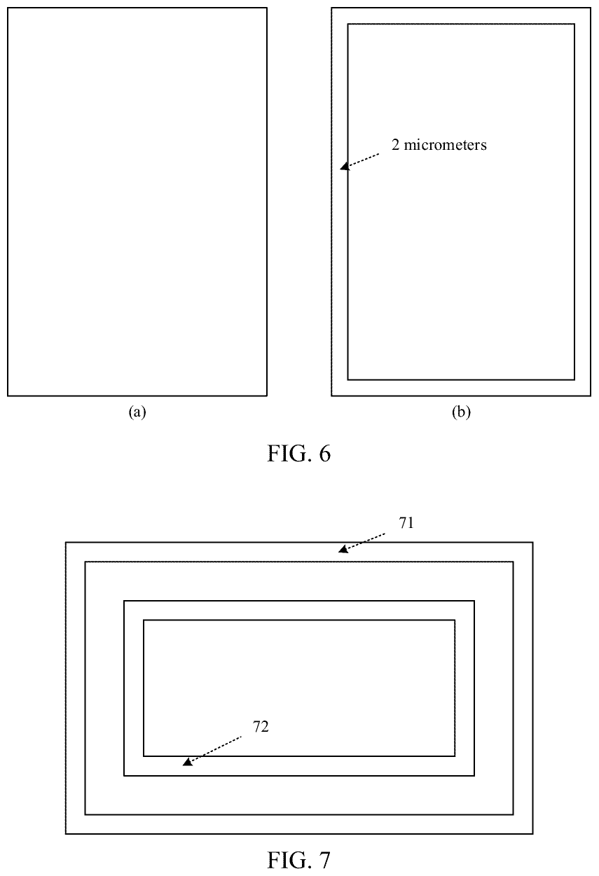

FIG. 6 is a schematic diagram of box generation of a line without a genus according to an aspect of this disclosure. A pattern of an input line is shown in section (a) in FIG. 6. The pattern of the line is a rectangle without a genus. The computer device may first determine the boundaries of the pattern (for example, coordinates of four corner points of the pattern are determined). The pattern is expanded or shrunk along the boundary according to the size and sign of a compensation numerical value (that is, the box correction value), to generate a closed box (to be specific, the line of the box has a specific width, and the width is the box correction value), for compensating and correcting the pattern. For example, to resolve a problem of size expanding caused by wet etching, an aspect of this disclosure shrinks the layout. For the input pattern shown in section (a) in FIG. 6, it is necessary to generate a shrinkage pattern inward along the boundary of the pattern. As shown in section (b) in FIG. 6, the thickness of the box is a target compensation value (that is, the box correction value). For example, if a processor feeds back that the etching expanding (a positive error) under a current process condition is 2 microns, then a thickness of the box shown in section (b) in FIG. 6 is also 2 micrometers. On the contrary, if the line needs to be widened, a box needs to be generated outward along a pattern boundary.

In an implementation, the generating the correction box based on the initial position information of the line in the initial circuit layout and the box correction value according to the genus detection information may include:
segmenting, in response to the genus detection information indicating that a region covered by the line has a genus, the boundary of the line to obtain at least one outer boundary box and at least one inner boundary box, where the outer boundary box is a box enclosed by an outer boundary of the line, and the inner boundary box is a box enclosed by a boundary of the genus in the line;
adding, given initial position information of the at least one outer boundary box, the box correction value to the at least one outer boundary box to obtain at least one outer boundary correction box; that is, adding, based on initial position information of the at least one outer boundary box, the box correction value to the at least one outer boundary box to obtain at least one outer boundary correction box, where because the box correction value is positive and negative, when the box correction value is positive, an effect of adding the box correction value to at least one outer boundary box is to start from at least one outer boundary box and expand to the outside of the dual-concentric square-shaped line; on the contrary, when the box correction value is negative, an effect of adding the box correction value to the at least one outer boundary box is to start from at least one outer boundary box and expand to the inside of the dual-concentric square-shaped line; for example, for a point on the outer boundary box, a normal direction of the point on the outer boundary box is determined, and then the point moving toward the outside or inside of the line to the box correction value along the normal direction is calculated based on a coordinate of the point in the initial position information, to obtain a coordinate of a corresponding point in the outer boundary correction box; the above processing is performed for each point on the outer boundary box, to be specific, the coordinates of each point in the outer boundary correction box may be obtained;
subtracting, given initial position information of the at least one inner boundary box, the box correction value from the at least one inner boundary box to obtain at least one inner boundary correction box; that is, subtracting, based on initial position information of the at least one inner boundary box, the box correction value from the at least one inner boundary box to obtain at least one inner boundary correction box; where because the box correction value is positive and negative, when the box correction value is positive, an effect of subtracting the box correction value from at least one inner boundary box is to start from at least one inner boundary box and expand to the inside of the dual-concentric square-shaped line; on the contrary, when the box correction value is negative, an effect of subtracting the box correction value from at least one inner boundary box is to start from at least one inner boundary box and expand to the outside of the dual-concentric square-shaped line; for example, for a point on the inner boundary box, a normal direction of the point on the inner boundary box is determined, and then the point moving toward the outside or inside of the line to the box correction value along the normal direction is calculated based on a coordinate of the point in the initial position information, to obtain a coordinate of a corresponding point in the inner boundary correction box; the above processing is performed for each point on the inner boundary box; to be specific, coordinates of each point in the inner boundary correction box may be obtained; and
obtaining the at least one outer boundary correction box and the at least one inner boundary correction box as the correction box.

FIG. 7 is a schematic diagram of a box of a line with a genus according to an aspect of this disclosure. Using a pattern of a dual-concentric square-shaped line with a single genus as an example, the generated correction box includes an outer boundary correction box 71 and an inner boundary correction box 72. The outer boundary correction box 71 is a pattern obtained by extending inward/outward based on an outside boundary of the dual-concentric square-shaped line (that is, adding a box correction value to at least one outer boundary box). The inner boundary correction box 72 is a pattern obtained by extending in an opposite direction based on the outer boundary box of the dual-concentric square-shaped line (that is, subtracting the box correction value from at least one inner boundary box). The effect of generating a compensation box (that is, the outer boundary correction box 71 and the inner boundary correction box 72) is shown in FIG. 7. In this way, the compensation correction processing is performed after the boxes are generated on both the inner and outer boundaries of the pattern at the same time, so that problems such as pattern fracture and overlap are prevented.

By executing circuit layout processing code, the computer device first processes reading of the layout and parameters, and then enters a core part of the code. The part needs to determine whether the pattern has a “genus” and a corresponding process is performed. In a core function, after it is determined that the pattern with a line does not have a “genus”, a split variable is first used to store whether a “genus” exists (that is, the split variable is used to mark whether the pattern has a genus). If not, an entire etching boundary (that is, the correction box) is drawn according to the following code:

If(!split) //If the mark is split;
{
//no attach point detected, just continue; //no attach point detected, just continue;
appendFp (cell, target_point_array, offset); //call AppendFp function;
return; //return
}

In the above code, input parameters of the appendFp function include cell, target_point_array, and offset, where cell is an output file name, target_point_array is position information of a pattern (an array in a point set format), and offset is a box correction value.

An example in which the line containing a single genus is used. If a genus exists, subsequent code segment an entire boundary of a pattern of the line into two segments to form two boxes (that is, the outer boundary box and the inner boundary box), and then the two rings are drawn separately according to the following code:
appendFp (cell, ring1, offset); //call AppendFp function;
appendFp (cell, ring2, −offset); //call AppendFp function;

In the above code, ring1 is position information of the outer boundary box (an array in a point set format), and ring2 is position information of the inner boundary box.

For the pattern with a genus in the above solution of this disclosure, only an example in which a dual-concentric square-shaped pattern with a single genus is used for description. A processing method of patterns with a genus in other shapes is similar to that of the processing method of the dual-concentric square-shaped pattern with a genus. Details are not described herein again.

For the above aspects of this disclosure, only rectangles are used as an example for description of the pattern without a genus. A processing method for the pattern without a genus in other shapes is similar to that of the rectangular pattern. Details are not described herein again.

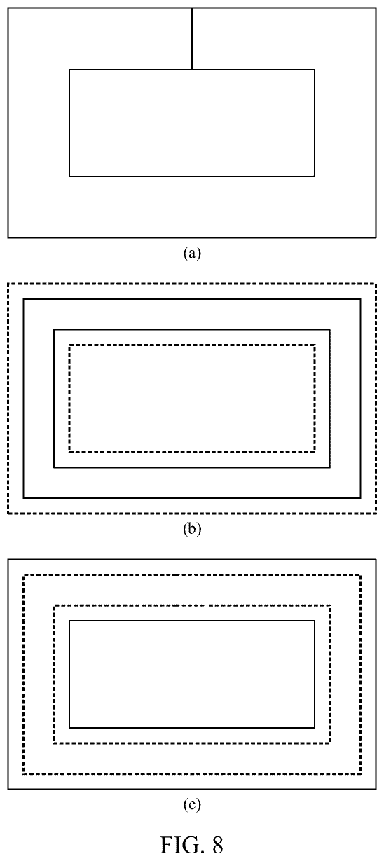

By using the solutions of this disclosure, when performing compensation correction on a line pattern with a genus (for example, a pattern with a genus of 1 and at least one common point on a common edge), problems such as breakage and overlap of the pattern do not occur. In this way, it is better ensured that an etched pattern does not damage an original device structure. For example, FIG. 8 is a diagram of a processing effect of a dual-concentric square-shaped line pattern according to an aspect of this disclosure. Section (a) in FIG. 8 shows a pattern of a dual-concentric square-shaped line in input initial circuit layout. Section (b) in FIG. 8 shows a pattern after the layout is narrowed. Section (c) in FIG. 8 shows a pattern after the layout is enlarged. Dashed line boxes in FIG. 8 are boundaries of a corrected pattern.

Step 404: Correct the boundary of the line in the initial circuit layout based on the correction box to obtain a corrected circuit layout.

In an aspect of this disclosure, after obtaining the correction box, the computer device may expand or narrow the boundary of the line in the initial circuit layout based on the correction box to obtain the corrected circuit layout.

In an implementation, the correcting the boundary of the line in the initial circuit layout based on the correction box to obtain corrected circuit layout includes performing a Boolean operation on the initial position information of the line in the chip and position information of the correction box to obtain the corrected circuit layout.

The computer device may correct the boundary of the line in the initial circuit layout based on the correction box by using a manner of a Boolean operation.

In an implementation, the performing a Boolean operation on the initial position information of the line in the chip and position information of the correction box to obtain the corrected circuit layout includes performing a merge operation on the initial position information of the line in the chip and the position information of the correction box in a case that the correction box is located outside the boundary of the line in the initial circuit layout.

In a case that the correction box is located outside the boundary of the line in the initial circuit layout (for example, the computer device may determine whether the correction box is located outside the boundary of the line in the initial circuit layout based on a size relationship of coordinate values), it means that the correction box is obtained by extending the boundary of the line in the initial circuit layout. At this time, a merge operation may be performed on the initial position information of the line and the position information of the correction box. That is, a pattern of the correction box is added to an initial pattern of the line to obtain a line corrected pattern.

In an implementation, the performing a Boolean operation on the initial position information of the line in the chip and position information of the correction box to obtain the corrected circuit layout includes performing a subtract operation on the initial position information of the line in the chip and the position information of the correction box in a case that the correction box is located inside the boundary of the line in the initial circuit layout.

In a case that the correction box is located inside the boundary of the line in the initial circuit layout, it means that the correction box is obtained by shrinking the boundary of the line in the initial circuit layout. At this time, a subtraction operation may be performed on the initial position information of the line and the position information of the correction box. That is, a pattern of the correction box is subtracted from the initial pattern of the line to obtain a line corrected pattern.

In an implementation, the performing a Boolean operation on the initial position information of the line in the chip and position information of the correction box to obtain the corrected circuit layout includes performing a merge operation on the initial position information of the line in the chip and the position information of the correction box in a case that the box correction value is a positive value.

In an implementation, the performing a Boolean operation on the initial position information of the line in the chip and position information of the correction box to obtain the corrected circuit layout includes performing a subtract operation on the initial position information of the line in the chip and the position information of the correction box in a case that the box correction value is a negative value.

In another example solution of this disclosure, the computer device may also determine whether to use the merge operation or the subtraction operation in other ways. For example, in a case that the value of offset is positive, the merge operation is performed on the initial position information of the line in the chip and the position information of the correction box. Otherwise, in a case that the value of offset is negative, the subtract operation is performed on the initial position information of the line in the chip and the position information of the correction box.

Effects of the Boolean operation may be as follows:
(1) For a complete pattern without a genus

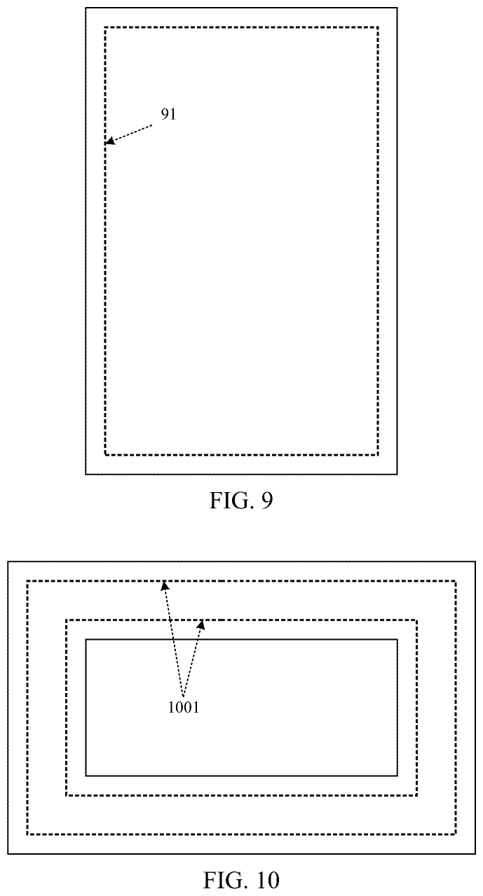

FIG. 9 shows a processing effect of a pattern without a genus according to this aspect of this disclosure. After the correction box is generated, a Boolean operation needs to be performed on a box and an original pattern. To shrink the size of the line pattern in the layout, it is necessary to perform a subtract operation on the box in section (b) in FIG. 6 and the original pattern in section (a) in FIG. 6 to obtain a shrunk pattern. As shown in FIG. 9, the shrunk pattern is represented by a dashed line box 91. On the contrary, if the layout needs to be widened, a merge operation needs to be performed on the box and the layout.
(2) For a “dual-concentric square-shaped” pattern with a genus of 1

FIG. 10 shows a processing effect of a pattern with a genus according to an aspect of this disclosure. After the correction box is generated for the inner and outer boundaries of the “dual-concentric square-shaped” pattern, a Boolean operation may be performed on an original pattern and a correction box as needed. FIG. 10 shows the effect of shrinking the “dual-concentric square-shaped” pattern after subtraction. The boundary of a shrunk pattern is represented by a dashed line 1001. It can be seen that no crack is generated after the pattern shrinks.

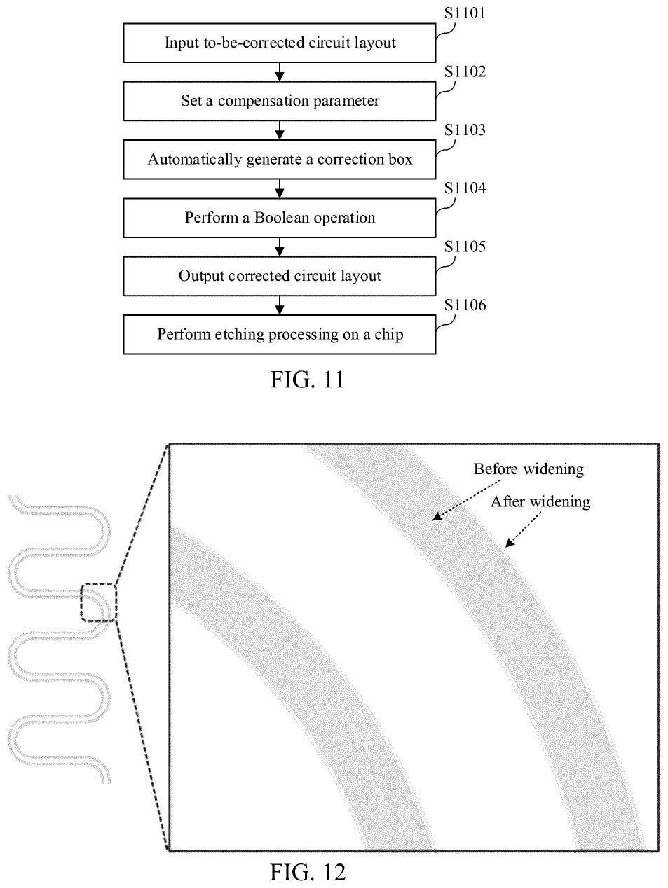

FIG. 11 is a flowchart of a solution according to an aspect of this disclosure. As shown in FIG. 11, the solution flowchart is as follows:

S1101: A user (a designer) inputs a to-be-corrected circuit layout.

S1102: The user sets a compensation parameter (a box correction value).

S1103: A compensation algorithm automatically generates a correction box based on the compensation parameter.

S1104: A Boolean operation is performed on the correction box and an original pattern, a merge or subtract operation is performed on the correction box and the original pattern, so that layout is widen or narrowed.

S1105: A corrected circuit layout is outputted.

S1106: Production line personnel perform etching on a chip based on the corrected circuit layout.

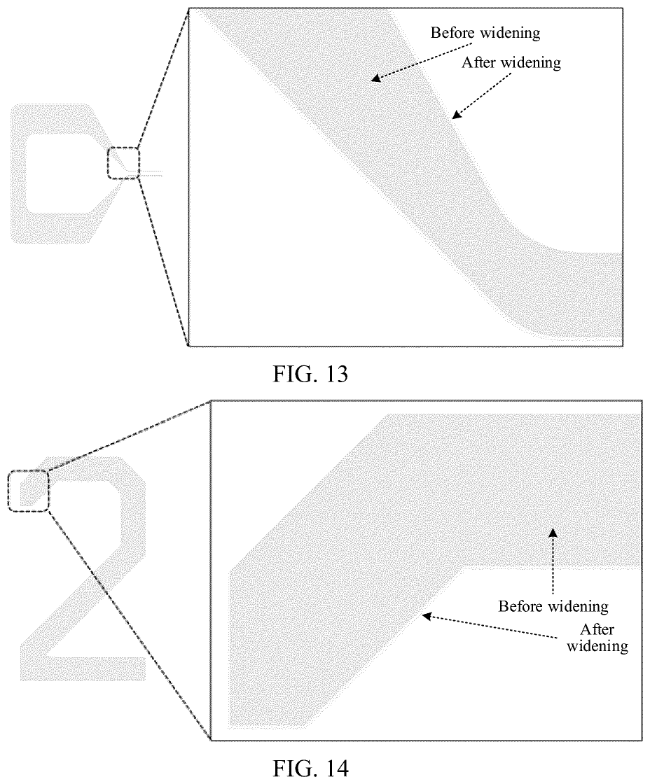

FIG. 12 shows an engineering implementation effect of widening a CPW resonance cavity on circuit layout. FIG. 13 shows an engineering implementation effect of widening a pad on circuit layout. FIG. 14 shows an engineering implementation effect of widening silkscreen on circuit layout.

Solutions of this disclosure may compensate for line size errors caused by etching during the manufacturing process of a superconducting quantum chip. In this solution, an impact of the etching error on device parameters and performance is reduced. In addition, chip design efficiency is improved. The solution may be widely applied to on-chip line size adjustment.

In conclusion, by using the solutions of this disclosure, for initial circuit layout of a designed chip, a line of initial circuit layout can be corrected based on the box correction value set by the etching error, so that the circuit layout can be automatically adjusted according to an error of an etching process during a chip design stage, thereby reducing an impact of an etching process error during the etching process of chip manufacturing, while ensuring design efficiency of the circuit layout of the chip.

In a solution of this disclosure, a size of a pattern such as CPW, components, and silkscreen on the layout may be expanded or shrunk automatically based on an inputted target compensation parameter (that is, the box correction value, where selection of the parameter is based on an experimental data feedback under a current process condition) without introducing additional problems such as pattern breakage or overlap on the layout. In this way, the workload of design and manufacturing personnel is greatly simplified, an impact of the etching error is avoided while improving chip design efficiency.

The solutions of this disclosure may have the following beneficial effects:
(1) Correcting etching errors during the processing of superconducting quantum chips;
(2) Global adjustment: Performing compensation correction on the size of all CPW lines, components, and silkscreen on the entire layout;
(3) Adjustable compensation parameters (which may be set or modified by a designer); and
(4) Allowing one-click adjustment of the layout size based on parameters.

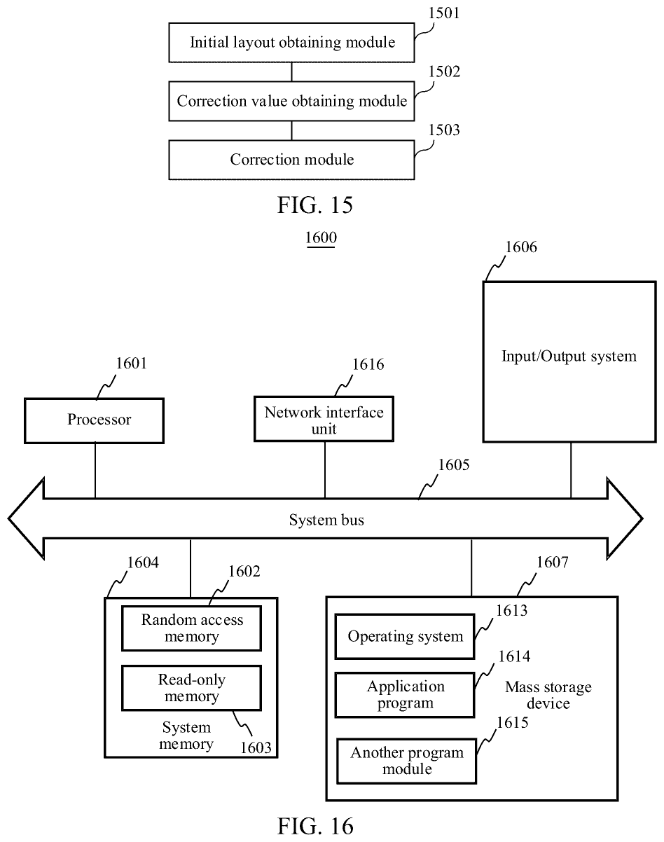

FIG. 15 is a block diagram of a structure of a circuit layout processing apparatus according to an aspect of this disclosure. The circuit layout processing apparatus may implement all or part of the steps performed by a computer device in the method provided by the aspects shown in FIG. 2 or FIG. 4. The circuit layout processing apparatus includes: an initial layout obtaining module 1501, a correction value obtaining module 1502, and a correction module 1503.

The initial layout obtaining module 1501 is configured to obtain initial circuit layout of a chip, the initial circuit layout including initial position information of a line in the chip.

The correction value obtaining module 1502 is configured to obtain a box correction value of the line, the box correction value being a correction value that is set based on an etching error during a process of processing the chip.

The correction module 1503 is configured to correct a boundary of the line in the initial circuit layout based on the initial position information and the box correction value to obtain corrected circuit layout.

The corrected circuit layout is configured to prepare the line in the chip by using an etching process.

In an implementation, the correction module 1503 is configured to generate a correction box of the boundary of the line in the initial circuit layout based on the initial position information and the box correction value. The correction module 1503 is configured to correct the boundary of the line in the initial circuit layout based on the correction box to obtain the corrected circuit layout.

In an implementation, the correction module 1503 is configured to perform a Boolean operation on the initial position information and position information of the correction box to obtain the corrected circuit layout.

In an implementation, the correction module 1503 is configured to perform a merge operation on the initial position information and the position information of the correction box in a case that the box correction value is a positive value.

In an implementation, the correction module 1503 is configured to perform a subtract operation on the initial position information and the position information of the correction box in a case that the box correction value is a negative value.

In an implementation, the correction value obtaining module 1502 is configured to obtain genus detection information of the line, the genus detection information being used for indicating whether a genus exists in the line. The correction value obtaining module 1502 is configured to generate the correction box based on the initial position information and the box correction value according to the genus detection information.

In an implementation, the correction value obtaining module 1502 is configured to add, in response to the genus detection information indicating that no genus exists in the line, the box correction value based on the initial position information of the boundary of the line to obtain the correction box.

In an implementation, the correction value obtaining module 1502 is configured to segment, in response to the genus detection information indicating that the line has a genus, the boundary of the line to obtain at least one outer boundary box and at least one inner boundary box, where the outer boundary box is a box enclosed by an outer boundary of the line, and the inner boundary box is a box enclosed by a boundary of the genus in the line. The correction value obtaining module 1502 is configured to add, based on initial position information of the at least one outer boundary box, the box correction value based on the at least one outer boundary box to obtain at least one outer boundary correction box. The correction value obtaining module 1502 is configured to subtract, based on initial position information of the at least one inner boundary box, the box correction value from the at least one inner boundary box to obtain at least one inner boundary correction box. The correction value obtaining module 1502 is configured to obtain the at least one outer boundary correction box and the at least one inner boundary correction box as the correction box.

In an implementation, the correction value obtaining module 1502 is configured to obtain first genus detection information in response to position information of repeated points existing in the initial position information of the line, the first genus detection information being used for indicating that a genus exists in a region covered by the line. The correction value obtaining module 1502 is configured to obtain second genus detection information in response to no position information of repeated points existing in the initial position information of the line, the second genus detection information being used for indicating that no genus exists in the region covered by the line.

In an implementation, the chip is a superconducting quantum chip.

In an implementation, the line includes at least one of a coplanar waveguide line, a component, and silkscreen.

In conclusion, by using solutions of this disclosure, for initial circuit layout of a designed chip, a line of initial circuit layout can be corrected based on the box correction value set by the etching error, so that the circuit layout can be automatically adjusted according to an error of an etching process during a chip design stage, thereby reducing an impact of an etching process error during the etching process of chip manufacturing, while ensuring design efficiency of the circuit layout of the chip.

When the apparatus provided in the foregoing aspect implements functions of the apparatus, division of the foregoing functional modules is merely used as an example for description. In practical application, the foregoing functions may be allocated to different functional modules for implementation based on a requirement. To be specific, an internal structure of a device is divided into different functional modules, to implement all or some of the functions described above. In addition, the apparatus provided in the above-mentioned examples and the method examples may be based on the same conception. For details of an example of the implementation process, reference may be made to the method examples. Details are not described herein again.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

FIG. 16 is a schematic diagram of a structure of a computer device according to an aspect. The computer device 1600 includes processing circuitry or a processor 1601, such as a central processing unit (CPU), a system memory 1604 including a random access memory (RAM) 1602 and a read-only memory (ROM) 1603, and a system bus 1605 connecting the system memory 1604 to the processor 1601. The computer device 1600 further includes an input/output system 1606 assisting in information transmission between components in the computer, and a mass storage device 1607 configured to store an operating system 1613, an application program 1614, and another program module 1615.

The mass storage device 1607 is connected to the processor 1601 by using a mass storage controller (not shown) connected to the system bus 1605. The mass storage device 1607 and a computer-readable medium associated with the mass storage device provide non-volatile storage to the computer device 1600. To be specific, the mass storage device 1607 may include a computer-readable medium (not shown) such as a hard disk or a compact disc read-only memory (CD-ROM) drive.

In general, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes RAM, ROM, flash memory or other solid-state storage technologies, CD-ROM, or other optical storage, magnetic tape cassettes, magnetic tapes, magnetic disk storage or other magnetic storage devices. Certainly, a person skilled in the art would understand that the computer storage medium is not limited to the foregoing several types. The system memory 1604 and the mass storage device 1607 may be collectively referred to as a memory.

The computer device 1600 may be connected to the Internet or other network devices through a network interface unit 1616 connected to the system bus 1605.

The memory further includes one or more computer instructions. The one or more computer instructions are stored in the memory. The processor 1601 implements all or partial steps of the method shown in FIG. 2 or FIG. 4 by executing the one or more computer instructions.

In an aspect, a non-transitory computer-readable storage medium including an instruction is further provided, for example, a memory including a computer program (an instruction), and the foregoing program (the instruction) may be executed by a processor of the computer device to implement the methods shown in various aspects of this disclosure. For example, the non-transitory computer-readable storage medium may be a ROM, a RAM, a CD-ROM, a magnetic tape, a floppy disk, and an optical data storage device.

In an aspect, a computer program product or computer program is further provided. The computer program product or the computer program includes computer instructions. The computer instructions are stored in a computer-readable storage medium. The processor of the computer device reads the computer instructions from the computer-readable storage medium, and the processor executes the computer instructions, so that the computer device performs the method shown in the above-mentioned various aspects.

What is claimed is:

1. A circuit layout processing method, the method comprising:
obtaining an initial circuit layout of a chip, the initial circuit layout including initial position information of a line in the chip;
obtaining a correction value of the line, the correction value being set based on an etching processing error of the chip; and
correcting, by processing circuitry, a boundary of the line in the initial circuit layout based on the initial position information and the correction value to obtain a corrected circuit layout.

2. The method according to claim 1, wherein the correcting includes correcting the boundary of the line in the initial circuit layout based on the initial position information, the correction value, and whether the line includes a hole.

3. The method according to claim 1, wherein the correcting comprises:
generating a correction box of the boundary of the line in the initial circuit layout based on the initial position information and the correction value; and
correcting the boundary of the line in the initial circuit layout based on the correction box to obtain the corrected circuit layout.

4. The method according to claim 3, wherein the correcting the boundary of the line in the initial circuit layout based on the correction box comprises:
performing a Boolean operation based on the initial position information and position information of the correction box to obtain the corrected circuit layout.

5. The method according to claim 4, wherein the performing the Boolean operation comprises:
performing a merge operation based on the initial position information and the position information of the correction box when the correction value is a positive value.

6. The method according to claim 4, wherein the performing the Boolean operation comprises:
performing a subtract operation based on the initial position information and the position information of the correction box when the correction value is a negative value.

7. The method according to claim 3, wherein the generating the correction box comprises:
obtaining hole detection information of the line, the hole detection information indicating whether a hole exists in the line; and
generating the correction box based on the initial position information and the correction value according to the hole detection information.

8. The method according to claim 7, wherein the generating the correction box based on the initial position information and the correction value according to the hole detection information comprises:
adding, when the hole detection information indicates that no hole exists in the line, the correction value based on the initial position information of the boundary of the line to obtain the correction box.

9. The method according to claim 7, wherein the generating the correction box based on the initial position information and the correction value according to the hole detection information comprises:
segmenting, when the hole detection information indicates that the line has the hole, the boundary of the line to obtain at least one outer boundary box and at least one inner boundary box, the outer boundary box corresponding to an outer boundary of the line, and the inner boundary box corresponding to a boundary of the hole in the line;
adding, based on position information of the at least one outer boundary box, the correction value to the at least one outer boundary box to obtain at least one outer boundary correction box;
subtracting, based on position information of the at least one inner boundary box, the correction value from the at least one inner boundary box to obtain at least one inner boundary correction box; and
obtaining the correction box based on the at least one outer boundary correction box and the at least one inner boundary correction box.

10. The method according to claim 7, wherein the obtaining the hole detection information of the line comprising:
obtaining first hole detection information when position information of repeated points are included in the initial position information of the line, the first hole detection information indicating that a genus exists in the line; and
obtaining second genus detection information in response to no position information of repeated points existing in the initial position information of the line, the second genus detection information being used for indicating that no genus exists in the line.

11. The method according to claim 1, wherein the chip is a superconducting quantum chip.

12. The method according to claim 1, wherein the line includes at least one of a coplanar waveguide line, a component, or silkscreen.

13. A circuit layout processing apparatus, comprising:
processing circuitry configured to:
obtain an initial circuit layout of a chip, the initial circuit layout including initial position information of a line in the chip;
obtain a correction value of the line, the correction value being set based on an etching processing error of the chip; and
correct a boundary of the line in the initial circuit layout based on the initial position information and the correction value to obtain a corrected circuit layout.

14. The circuit layout processing apparatus according to claim 13, wherein the processing circuitry is configured to:
correct the boundary of the line in the initial circuit layout based on the initial position information, the correction value, and whether the line includes a hole.

15. The circuit layout processing apparatus according to claim 13, wherein the processing circuitry is configured to:
generate a correction box of the boundary of the line in the initial circuit layout based on the initial position information and the correction value; and
correct the boundary of the line in the initial circuit layout based on the correction box to obtain the corrected circuit layout.

16. The circuit layout processing apparatus according to claim 15, wherein the processing circuitry is configured to:
perform a Boolean operation based on the initial position information and position information of the correction box to obtain the corrected circuit layout.

17. The circuit layout processing apparatus according to claim 16, wherein the processing circuitry is configured to:
perform a merge operation based on the initial position information and the position information of the correction box when the correction value is a positive value.

18. The circuit layout processing apparatus according to claim 16, wherein the processing circuitry is configured to:
perform a subtract operation based on the initial position information and the position information of the correction box when the correction value is a negative value.

19. The circuit layout processing apparatus according to claim 15, wherein the processing circuitry is configured to:
obtain hole detection information of the line, the hole detection information indicating whether a hole exists in the line; and
generate the correction box based on the initial position information and the correction value according to the hole detection information.

20. A non-transitory computer-readable storage medium, storing instructions which when executed by a processor cause the processor to perform:
obtaining an initial circuit layout of a chip, the initial circuit layout including initial position information of a line in the chip;
obtaining a correction value of the line, the correction value being set based on an etching processing error of the chip; and
correcting a boundary of the line in the initial circuit layout based on the initial position information and the correction value to obtain a corrected circuit layout.
